(19) United States
(12) Patent Application Publication
(10) Pub. No.: US 2006/0157607 A1
(43) Pub. Date: Jul. 20, 2006

(54) Seat belt retractor with belt tightener

(76) Inventors: Kenneth H. Kohlndorfer, Roseville, MI (US); Richard W. Koning, Yale, MI (US); Robert E. Verhoven, Harsens Island, MI (US); Barney J. Bauer, Rochester, MI (US); Tony Jain, Rochester Hills, MI (US)

Correspondence Address: KEY SAFETY SYSTEMS, INC.;PATENT DEPARTMENT, 7000 NINETEEN MILE ROAD, STERLING HEIGHTS, MI, 48314, US

(21) Appl. No.: 11/313,709

(22) Filed: Dec. 21, 2005

Related U.S. Application Data
(60) Provisional application No. 60/638,622, filed on Dec. 22, 2004.

(51) Int. Cl. B60R 22/46

(52) U.S. Cl. 242/374

(57) ABSTRACT

A seat belt system (10) comprising: a seat belt retractor (20) having a rotationally mounted spool and a quantity of seat belt wound thereabout; a belt tightener (210) comprising a hollow tube having a circular cross-section; a cylindrically shaped piston (230) moveable within the tube and including a plurality of annular, adjacent teeth.

This application claims the benefit of U.S. Provisional Application 60/638,622, filed on Dec. 22, 2004. The disclosure of the above application is incorporated herein by reference.

### BACKGROUND AND SUMMARY OF THE INVENTION

The present invention relates to belt tighteners (also known as pretensioners) for seat belt retractors.

It is rather commonplace to utilize a seat belt tightener in automotive safety systems. These belt tighteners typically operate in conjunction with a seat belt buckle or seat belt retractor. When activated, the belt tightener attempts to remove slack in a seat belt system disposed about an occupant to be protected. Buckle belt tighteners (or pretensioners) move the buckle downwardly approximately 100 millimeters and in doing so remove slack in the lap belt and shoulder belt of a 3-point seat belt system. In contrast, the retractor pretensioner or belt tightener causes the spool of the retractor to rotate in a belt-winding direction. As the seat belt is rewound onto the spool, slack about the occupant is eliminated.

A typical prior art pretensioner or belt tightener comprises a pinion gear secured to and rotatable with the spool of the retractor. The pinion gear (or pinion) in turn is rotated by a toothed rack. The rack generally comprises a plurality of gear teeth that are machined on one side of the rack. The rack is moveably situated within a tube or housing that is attached to the frame of the seat belt retractor. During the normal operating cycle of the seat belt retractor, the rack is maintained out of engagement with the teeth of the pinion gear. Upon sensing a crash, a pyrotechnic element (a gas generator) also in the tube or piston housing is activated, which urges the rack into engagement with the pinion, thereby causing the spool to rotate in a belt-tightening direction. In essence, the rack operates as a movable piston accelerated by the products of combustion of the associated gas generator.

A characteristic of the prior art is the length of the teeth of the rack is approximately 70 millimeters. Upon activation of the pyrotechnic element, the toothed rack will stay in engagement with the pinion gear for a relatively long time (because of its length), accelerating the pinion gear and hence the spool in the belt-tightening direction.

It is an object of the present invention to provide a simple and robust retractor belt tightener.

Accordingly the invention comprises: a seat belt system comprising: a seat belt retractor having a rotationally mounted spool and a quantity of seat belt wound thereabout; a belt tightener comprising a hollow tube having a circular cross-section; a cylindrically shaped piston moveable within the tube and including a plurality of annular, adjacent teeth.

Many other objects and purposes of the invention will be clear from the following detailed description of the drawings.

### BRIEF DESCRIPTION OF THE DRAWINGS

FIG. 1 is a prospective view showing the major components of the present invention.

FIG. 2 is an enlarged view of a portion of FIG. 1 showing a piston and a pinion gear.

FIG. 2a shows another embodiment of the invention similar to FIG. 2.

FIG. 3 is a cross-sectional view illustrating a piston within a tube.

FIG. 4 is an alternate embodiment of the invention.

FIG. 5 illustrates the movement of the piston and rewind action of the spool.

FIG. 6 shows another operational state of the invention.

### DETAILED DESCRIPTION OF THE DRAWINGS

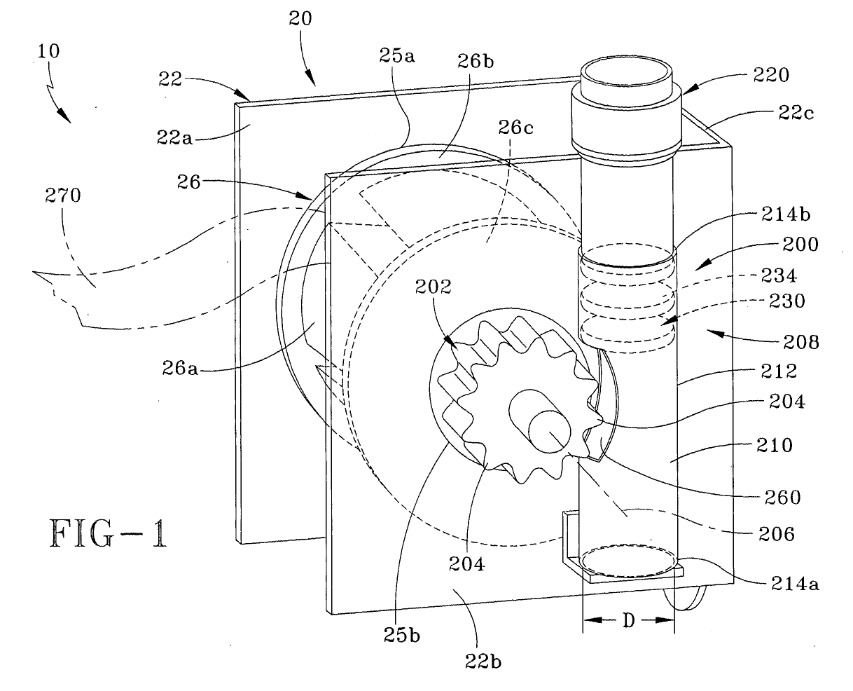

Reference is made to FIG. 1, which illustrates many of the components of a seat belt system 10 having a seat belt retractor 20 having a belt tightener 200. The seat belt retractor comprises a generally U-shaped frame 22 having frame sides 22a and 22b and a connecting rear portion or side 22c, which is often mounted to a mounting surface including a pillar of the vehicle or a frame of a seat. Each of the frame sides 24a and 24b includes a respective opening 25a and 25b. The retractor additionally includes a spool 26 of conventional design that is rotationally supported upon the frame sides 22a and 22b. The spool 26 includes a center core 26a and an opposing set of flanges 26b and 26c, each received in one of the openings 25a or 25b. Seat belt webbing 270 (shown in phantom line in FIG. 1) is secured to the spool 26 and wound about the spool 26 in a known manner. The seat belt retractor, the webbing, associated buckles, tongues and anchorages are configured into a multi-point (typically a 3 or 4-point system) to protect the occupant of the vehicle.

As is known in the art and often required by Governmental regulations, seat belt retractors include one or more inertial sensors including a vehicle sensor, which initiates the locking-up of the seat belt retractor when the vehicle, in which the seat belt retractor is mounted, experiences a rapid and sustained deceleration. Seat belt retractors additionally include another inertial sensor often referred to as a web sensor, which initiates the locking-up of the retractor during conditions in which the seat belt is protracted at a given rate from the spool 26.

The retractor additionally includes a lock mechanism, such as a rotatable lock panel mounted to the forward retractor and a toothed lock wheel mounted to the flange of the spool or formed on the spool, which when activated by either of the inertial sensors prevents further rotation of the spool. Lock mechanisms, rewind springs, and inertial sensors are known in the art. European Patent Application EP0228729A1 is representative of prior art lock mechanisms and is incorporated herein by reference.

The retractor 20 includes a belt tightener 200 comprising a gear set, which includes a pinion gear 202 having a plurality of teeth 204 disposed about the periphery of the gear. The pinion gear is mounted collinear to axis 206 of the spool and may be formed as an integral part of the spool or attached thereto and extends through opening 25b. In the preferred embodiment of the invention, a single pinion gear is utilized; however, a gear set comprising a plurality of interacting gears is within the scope of the present invention.

The belt tightener 200 additionally includes a piston assembly 208 including a tube 210, preferably one that is seamless. The tube can be made of stainless steel or another steel having a high strength modulus, and may be formed as a drawn part. The tube includes a wall 212 having a circular cross-section having an inner diameter D. The tube includes opposing ends 214a and 214b. End 214b is open. A gas generator 220 of known variety is seated in a fluid tight relationship within the open end 214b of the tube. In the preferred embodiment the tube has a stepped shaped with a larger diameter portion proximate end 214b to receive the gas generator 220. The gas generator is secured to end 214b of the tube by crimping or welding or other known methods. The tube 210 is secured to a frame side such as 22b proximate opening 25b. The tube 210 includes an opening 260 into which the teeth 204 of the pinion gear 202 extend. Typically opening 260 can be formed by machining or stamping.

A piston 230 is spaced below the gas generator 220 and movable within the lower portion of the tube 210. The products of combustion produced by the gas generator bear against the piston 230, pushing the piston down the tube. Prior to activation, the piston 230 is maintained remote from the teeth 204 of the pinion gear 202 as discussed below.

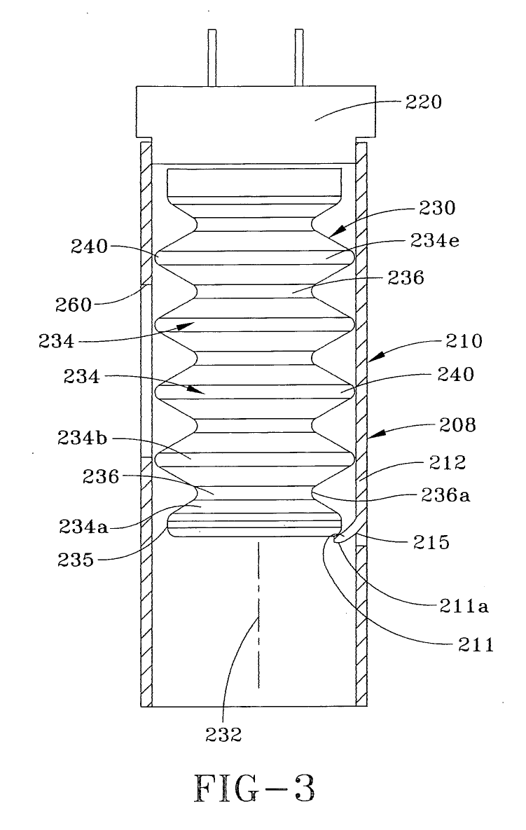

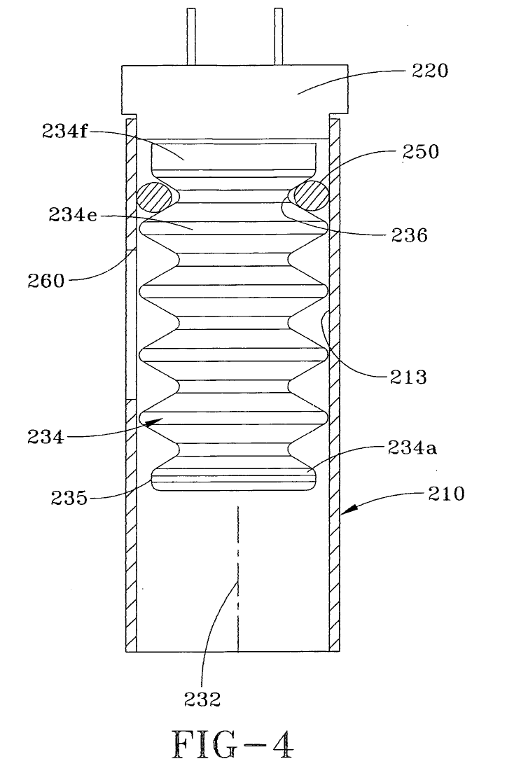

Reference is again made to FIG. 1, as well as to FIG. 4, which illustrate the belt tightener in a non-active mode with the pinion gear 202 extending into the window 260 and the piston 230 is spaced from the pinion 202. The piston 230 is a right-circular cylinder and is symmetric about an axis 232 and includes a plurality of cylindrically shaped teeth 234 (shown in greater detail in FIG. 3). Each tooth 234 is formed as a raised annulus or ring extending completely about the piston 230. A first tooth 234a of the piston 230 includes a truncated tip 235, which is used to synchronize the motion between the teeth 204 of the pinion gear with the teeth 234 of the piston or rack 230 to avoid tip-to-top loading.

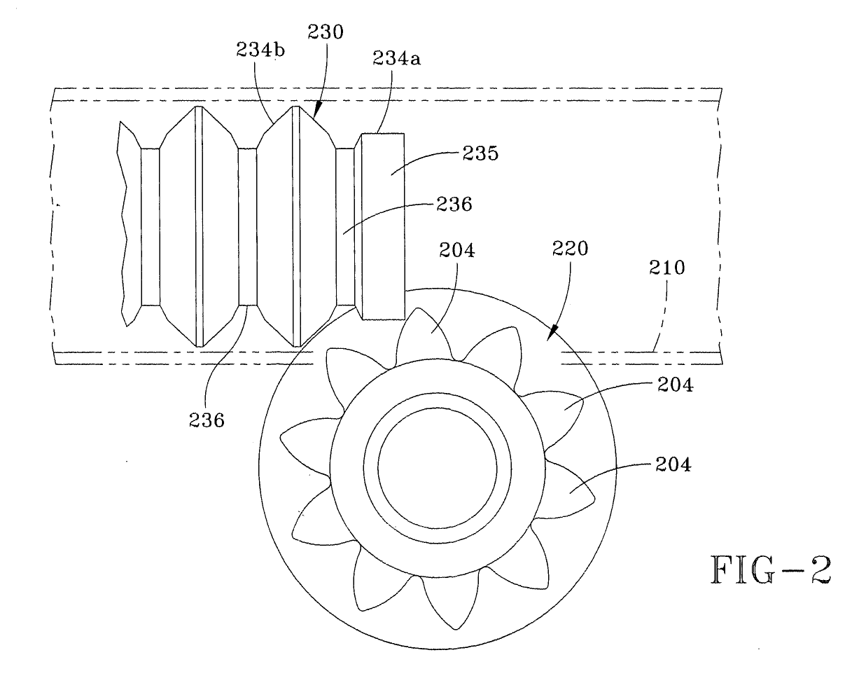

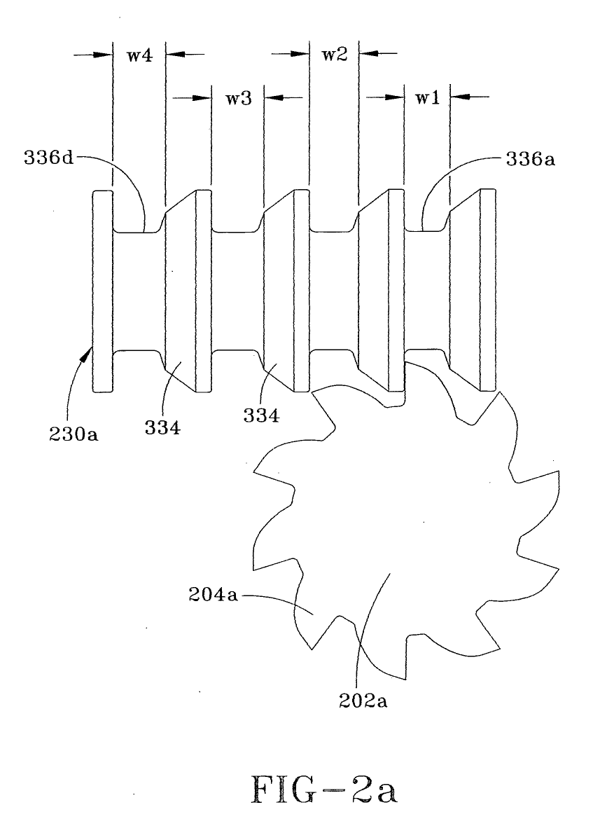

Located between adjacent teeth, such as 234a, 234b, 234n, is a corresponding smaller, cylindrical section or root 236. In the illustrated embodiment the root 236 is formed as a concave cylindrical wall 236a but can be flat (see numeral 239 in FIG. 2). Additionally, each of the teeth 234b-234n, with the exception of the truncated first tooth, comprises a conically shaped tip 240, designed to operatively engage the corresponding teeth 204 of the pinion gear 202. The piston 230, including its teeth, is made using a cold-roll process. The initial tooth 234a may require post-rolling machining to truncate the shape of this tooth. In the preferred embodiment the inner diameter of the tube is in the range of about 13-17 mm and the diameter of the piston is closely matched with an annular spacing or tolerance therebetween of about 01.25 and 025 mm. With this spacing it is not necessary to provide a separate fluid or gas seal to prevent the complete blow-by of the gas past the piston 230.

One of the advantages of the present system is apparent upon assembly of the various parts of the belt tightener 200. By using a cylindrically shaped piston with annular teeth, the symmetry of the piston allows loading of the piston 230 into the tube 210 at any angular orientation of the piston about its axis 232. This mounting is not possible in the prior art.

As mentioned above, the piston 230 is spaced from the pinion gear prior to being activated. In one embodiment of the invention, after the piston 230 is placed within the tube 210, the tube is squeezed or cut, forming an indentation 215 as shown in FIG. 3. The indented inside wall 211 provides a deformable tab or stop 211a, which initially prevents the piston 230 from dropping down the tube 210. As will be seen, the stop 211a can be moved out of the way, permitting the piston 230 to move down the tube under the forces of the products of combustion produced by the gas generator 220. Upon activation of gas generator 220, the downward motion of the piston deforms tab 211a outwardly as the piston moves past the now deformed tab.

In another embodiment as shown in FIG. 4, an O-ring 250 is inserted within the space provided by root 236 and is positioned between two adjacent teeth, such as 234. In the illustrated embodiment the O-ring is placed between the last tooth and the next-to-last tooth. In the preferred embodiment of the invention, the piston 230 includes four full teeth and a first stud or truncated tooth 234a and symmetric upper truncated tooth 234f. The O-ring seal gently bears against the interior side 213 of the wall of the piston and provides added friction to hold the piston in place prior to activation of the gas generator. In addition to holding the piston in place, the O-ring 250 also prevents the blow-by of the gasses produced by the gas generator 210.

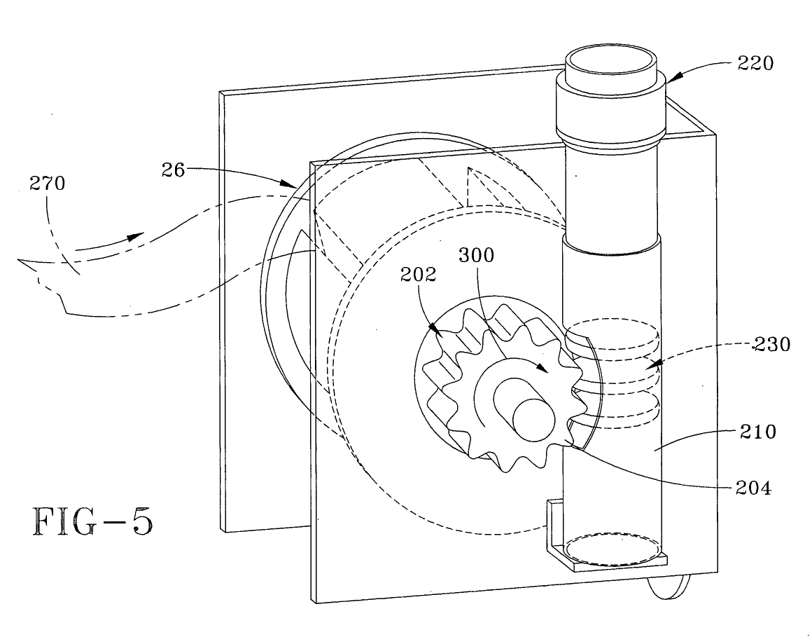

Reference is briefly made to FIG. 5, which illustrates the operation of a seat belt 20 having the above-described belt tightener 200. FIG. 2 shows the piston 230 accelerated down the tube 210 by the products of combustion produced by the gas generator 220 with the initial tooth 234a engaging one of the teeth 204 as the piston begins to rotate the pinion 202. In FIG. 5 the piston 230 has continued to be accelerated down the tube 210 by the products of combustion produced by the gas generator 220. The piston 230 has engaged one or more of the teeth 204 of the pinion gear 202 and caused the pinion to rotate in a clockwise manner (see arrow 300 shown in FIG. 5) causing the spool 26 to rotate in a belt-tightening (rewind) direction, rewinding the seat belt 270 back onto the spool 26.

FIG. 2a shows an alternate embodiment of the invention and in particular an alternate piston 230a and pinion gear 202a. The teeth 334 of the piston and teeth 204a of the pinion gear 202a are configured to one-way motion (down the tube). Further, the spacing w1-w4 of the roots 336a-d between adjacent teeth of the piston 230a increases from the forward end of the piston to the rear of the piston. This spacing prevents jamming of the piston with the tooth of the pinion. Experimentation has found that as the piston is accelerated down the tube the teeth of the pinion deflect. As mentioned, the varying spacing prevents jamming.

To achieve the maximum operation of the invention, it is desirable to configure the gas generator 220 so that there is sufficient gas produced to accelerate the piston 230 during the time the piston is in contact with the teeth 204 of the pinion gear 202.

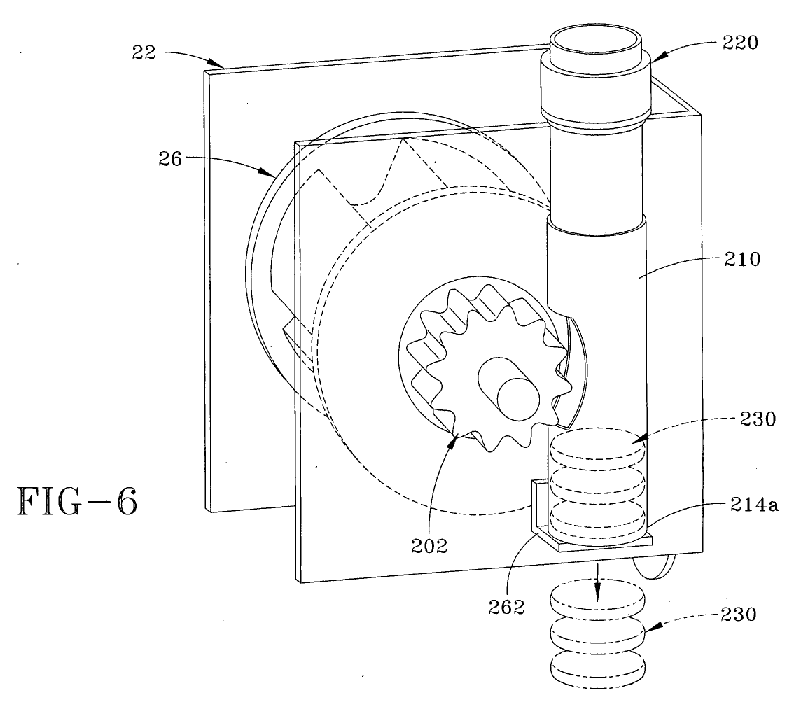

Reference is briefly made to FIG. 6, which illustrates the terminal condition of the present invention. In this condition, the piston 30 has been accelerated past the pinion gear 202 and has either been moved out of the tube 210 if end 214a is open (see phantom lines in FIG. 6) or has come to rest at a mechanical stop 262 formed at the terminal end 214a of tube 210. This mechanical stop can be formed by crimping the end 214a of the tube inwardly to locally reduce the diameter of the tube, or by inserting a pin across the end 214a of the tube or by partially covering the open end 214a of the tube with a bent-over piece of the frame. During the operation of the belt tightener, with the piston continuously powered by gas, the motion of the piston across the pinion gear has transferred sufficient momentum to the pinion gear and to the spool 26, which under most operational conditions will permit the spool to continue to rotate in a belt-tightening direction, even after the piston 230 has disengaged from the pinion gear and come to a stop. The end 214a of tube 210 can be configured to end generally in line with the bottom 27 of frame side 24b, or extend lower as shown by the dotted lines in FIG. 6.

Many changes and modifications in the above-described embodiment of the invention can, of course, be carried out without departing from the scope thereof. Accordingly, that scope is intended to be limited only by the scope of the appended claims.

1. A seat belt system (10) comprising:
a seat belt retractor (20) having a rotationally mounted spool (26) and a quantity of seat belt (270) wound thereabout;
a belt tightener (200) comprising a hollow tube (210) having a circular cross-section;
a piston (230) operatively connected to the spool and moveable within the tube and including a plurality of annular, adjacent teeth (234) symmetrically constructed about a central axis.

2. The system as defined in claim 1 including means for holding the piston in an inoperable condition relative to the spool.

3. The system as defined in claim 1 further including an O-ring seal (250) situated in a root space (236) between adjacent teeth (234) of the piston and configured to seal against an inner wall of the tube.

4. The system as defined in claim 2 including at least one pinion gear operatively connected to and moveable with the spool and driven by the piston.

5. The system as defined in claim 1 wherein the piston includes a number of teeth separated by root spaces, wherein the adjacent root spaces are of different dimension.

6. A seat belt system comprising:
a belt tightener (200) comprising a hollow tube having a circular cross-section and an opening (260) in a wall thereof;
a first pinion gear (202) having a plurality of teeth (204) thereon, at least some of the teeth extending into the tube through the opening in the tube wall;
a piston (230) operatively connected to the spool and moveable within the tube and including a plurality of annular, adjacent teeth.

7. The system as defined in claim 6 including a spool operatively connected to the pinion gear and configured to be rotated by the pinion gear.

8. The system as defined in claim 6 wherein the piston includes a number of teeth separated by root spaces, wherein at least two of the root spaces are of different dimension.

9. The system as defined in claim 6 wherein the piston includes a number of teeth separated by root spaces, wherein each root space is of different dimension.

10. The system of claim 5 wherein the piston is cylindrically shaped.
